(19) United States
(12) Patent Application Publication
(10) Pub. No.: US 2002/0098801 A1
(43) Pub. Date: Jul. 25, 2002

(54) Delayed random access

(75) Inventors: Arie Markus, Shoham (IL); Yoram Ofri, Rishon (IL)

Correspondence Address: BANNER & WITCOFF, 1001 G STREET N W, SUITE 1100, WASHINGTON, DC, 20001, US

(73) Assignee: Gilat Satellite Networks, Ltd., Petah Tikva (IL)

(21) Appl. No.: 10/051,294

(22) Filed: Jan. 22, 2002

Related U.S. Application Data
(60) Provisional application No. 60/262,421, filed on Jan. 19, 2001.

(51) Int. Cl. H04B 7/185

(52) U.S. Cl. 455/12.1; 455/13.1; 455/3.02

(57) ABSTRACT

A method and system for delayed random access is provided. In order to attempt to capture a channel, each VSAT randomly chooses when to load and where to transmit. Each of the VSAT schedules the transmission of data when the data that needs to be sent, utilizes more than a preset percentage of the channel and/or when a predetermined delay has elapsed. When multiple sources transmit data through a single VSAT, the system may withhold transmission until it aggregates enough data to efficiently utilize the channel. Alternatively, when there is a time out, the VSAT transmits the data regardless of the utilization of the channel. Blocking of a channel by a VSAT can be prevented so that the channel can be used by another VSAT in a more efficient manner.

This application claims priority to provisional U.S. Application Serial No. 60/262,421 filed Jan. 19, 2001.

### BACKGROUND OF THE INVENTION

The present invention relates to the field of two-way satellite communications. More particularly, the present invention relates to high capacity multi-purpose satellite communication systems optimized for two-way broadband communications via a bidirectional satellite communication system.

A VSAT network may be variously configured. In one configuration, a large number of terminals (VSATs) may be connected to a central station (hub) via a communication satellite. Coordinating the data transfer from the hub to the VSATs (Outbound) is relatively simple since the hub is a unique source of information. Coordinating the data transfer from the VSATs to the hub (Inbound) is more complex. There is a need for a multiple access scheme—an algorithm that allows a number of remote stations, the VSATs, to access and communicate over the shared media more efficiently.

Known multiple access schemes include TDMA (Time Division Multiple Access) where the inbound channels are divided in accordance with time-slots, FDMA (Frequency Division Multiple Access) where the inbound channels are divided in accordance with frequencies, and ALOHA where any VSAT may utilize any channel at any frequency (FDMA) and/or at any time (TDMA).

In many environments, a two dimensional FDMA/TDMA/ALOHA system may be utilized. Referring to FIG. 6, an exemplary FDMA/TDMA/ALOHA system 60 is shown where the time dimension is shown at 64, the frequency dimension is shown at 65, and each of the data slots are shown at 63. The data slots 63 may include a time component 62 and/or a frequency component 61. For example, in FIG. 6, the data slots 63 may include a frequency component 61 shown along the frequency dimension 65 and a time component 62 shown along the time dimension 64 such that each data slot may be two-dimensional.

Referring to FIG. 7, a conventional system 70 includes a plurality of data packets 71 (e.g., IP data packets) transmitted through a transmitter device 72 (e.g., a satellite card or standalone satellite transceiver). Each data packet 71 is placed in a data slot 74. However, where the data packet has a size which is smaller than the data slot 74, the packet only fills a first portion of the data slot 73 (used portion of the data slot), and a portion of the available data slot may be wasted 75 (wasted portion of the data slot). Hence, there is a need to increase the efficiency of the system.

Each data slot can output a predetermined number of bytes. However, the number of bytes actually transmitted depends on the data waiting in the transmit buffer. For example, where the data slot is 500 bytes and only a short acknowledge of 64 bytes was waiting, the utilization of the timeslot is very small (64/500=12.8%). This causes a great waste of system resources. Since the data slot size is typically a system wide parameter which does not dynamically vary with each transmission, it is not dynamically changeable on each transmission. Further, it is difficult if not impossible to calculate a system wide parameter that is optimum for every type of data at every transceiver location.

The above-mentioned problems may be exasperated in ALOHA systems due to the random access nature of the system. The random nature of ALOHA transmissions typically results in collisions of transmissions of different VSATs. In the event of a collision, the VSATs have to re-transmit their data. Thus, where there are large amounts of wasted bandwidth in the data slots, multiple transmissions of these data slots may result in substantial limitations on the throughput of the an ALOHA system in congested networks. The more congested the network, the higher the average delay. Further, the overall delay (e.g., the time required for a successful transmission) is conventionally not as predictable as is desired. Hence there is a need for a low cost two-way broadband satellite communication system that is more efficient.

### SUMMARY OF THE INVENTION

In order to overcome the disadvantages of conventional systems, there are a number of objects and associated aspects of the present invention.

Aspects of the present invention include a new random access scheme where each VSAT randomly chooses when or where to transmit, attempting to “capture” a channel. The VSATs schedule the transmission of data when the data that needs to be sent utilizes more than a preset percentage of the channel and/or when a predetermined delay has elapsed. Where there are a number of sources sending data through a single VSAT, the system may withhold transmitting until it has either aggregated enough data to efficiently utilize the channel, or in case of a timeout, may be configured to transmit the data regardless of the utilization of the channel. Using this access scheme, it is possible to prevent blocking a channel by a VSAT that would not efficiently utilize the channel, thus freeing it to other VSATs that would utilize it in a more efficient manner.

Further aspects of the invention include systems and methods for varying the accumulation time and/or utilization threshold in order to vary the grade of service allocated to a particular user and/or certain type of data.

It has been found that certain properties of real traffic patterns in satellite networks allow systems and methods in accordance with the present invention to substantially improve ALOHA performance measures such as throughput and channel usage characteristics.

These and other features of the invention will be apparent upon consideration of the following detailed description of preferred embodiments. Although the invention has been defined using the appended claims, the invention may include one or more aspects of the embodiments described herein including the elements and steps described in any combination or subcombination. For example, it is intended that each of the above aspects of the invention may be used individually and/or in combination with one or more other aspects of the invention defined above and/or in connection with the detailed description below. Accordingly, there are any number of alternative combinations for defining the invention, which incorporate one or more elements from the specification, including the description, claims, aspects of the invention, and/or drawings, in various combinations or subcombinations. Accordingly, it will be apparent to those skilled in satellite communication art in view of the present specification, that alternate combinations and subcombinations of one or more aspects of the present invention, either alone or in combination with one or more elements and/or steps defined herein, may constitute alternate aspects of the invention. It is intended that the written description of the invention contained herein cover all such modifications and alterations.

### BRIEF DESCRIPTION OF THE DRAWING

The foregoing summary of the invention, as well as the following detailed description of preferred embodiments, is better understood when read in conjunction with the accompanying drawings, which are included by the way of example, and not by way of limitation with regard to the claimed invention in the accompanying figure in which like reference numerals indicate similar elements.

FIG. 1 shows an exemplary block diagram of a two-way satellite system embodying aspects of the present invention.

FIG. 2 shows an exemplary block diagram of a local area network which may be disposed either in a residence, multi-dwelling unit, or office building.

FIG. 3 shows an exemplary block diagram of a personal computer with a LAN interface card and an interface to a satellite via either a satellite transceiver card or an input/output port to an external satellite transceiver.

FIG. 4 shows an exemplary memory queue structure which may be employed in accordance with aspects of the invention.

FIG. 5 shows a block diagram of a system in accordance with aspects of the present invention.

FIG. 6 shows a graphical illustration of a data slot in a conventional FDMA/TDMA/ALOHA system.

FIG. 7 shows the data slot utilization in a conventional system.

### DETAILED DESCRIPTION OF THE INVENTION

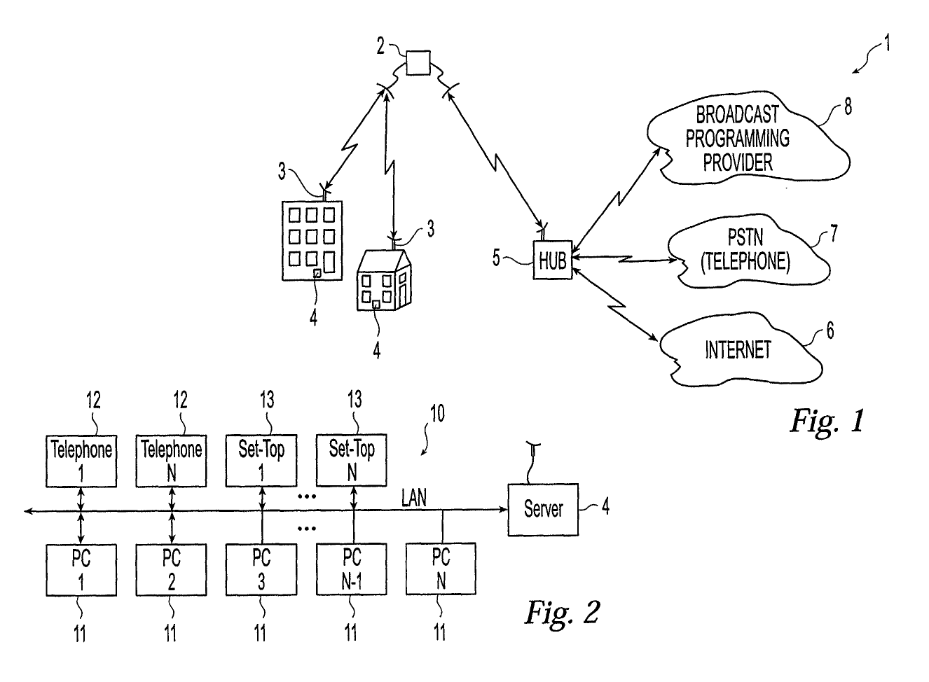

Referring to FIGS. 1, a two-way satellite system 1 includes a satellite 2 and a plurality of VSAT terminals 3 which may be disposed in a residence, multi-dwelling unit, and/or business, a computer 4 which may be any suitable computer router, or terminal device (e.g., a personal computer), a Hub 5, and a plurality of networks (e.g., the Internet 6, a public switched telephone network 7, and a broadcast source of programming such as a broadcast programming provider 8. The satellite system 1 may be variously configured to include one, two, three or more satellites. The VSAT terminals may be small or large aperture and may combine one or more low noise blocks. In the most preferred embodiments, the VSAT terminals are two-way terminals sharing an uplink (inbound) communication path using a multiple access scheme. In many embodiments, the multiple access scheme is one or more variants of a random access scheme such as an ALOHA scheme.

Referring to FIG. 2, a local area network 10 is shown. The local area network 10 may be any suitable network including a network included in a residence, office, multi-dwelling unit, or other suitable structure. The local area network 10 may include a server 4 which may be either a computer such as a standard PC and/or a dedicated satellite transceiver stand-alone unit such as is commonly available from Gilat Satellite Networks under the trademark Skystar Advantage™. The LAN may include one or more connected PCs 11, one or more connected telephones 12 (e.g., IP telephones and/or conventional telephones connected through an IP/DTMF adaptor) and/or one or more settop boxes (e.g., an IP settop box). Although IP has been used by way of example, another suitable protocol may also be utilized.

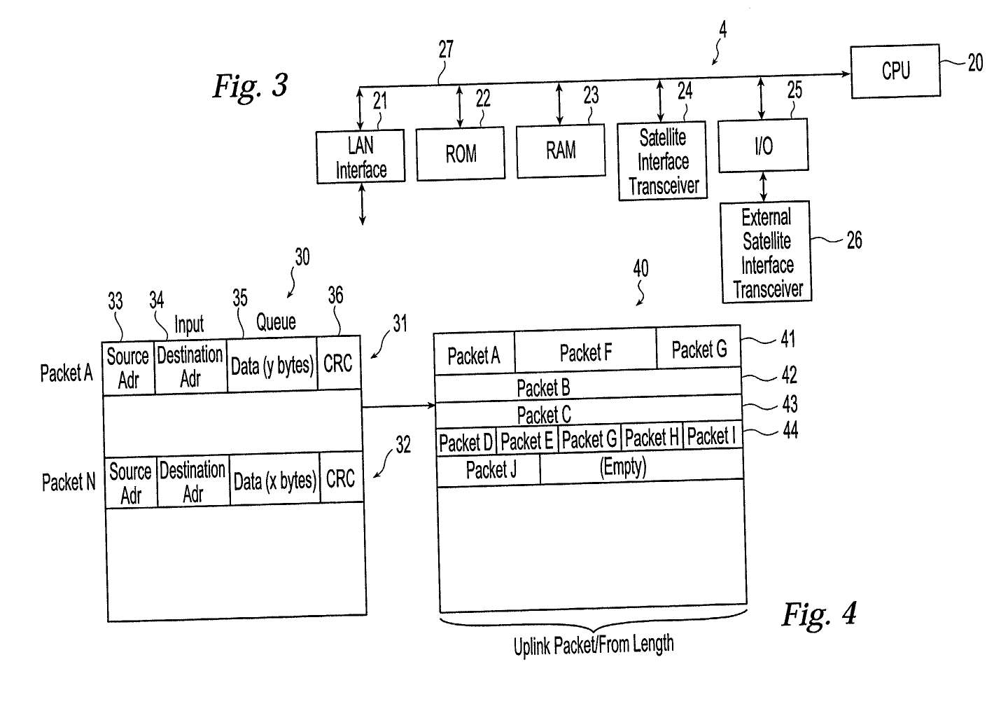

Referring to FIG. 3, the computer 4 may be variously configured to be any suitable device such as a standard personal computer PC. Where the computer 4 is implemented as a personal computer, it may be desirable to have any conventional internal architecture where one or more CPUs 20 are interconnected to a number of components such as a LAN interface 21, conventional memories (e.g., ROM 22 and RAM 23), a satellite interface (e.g., a transceiver card 24), and an input/output interface 25 (e.g., an I/O interface connected to an external satellite transceiver 26) via one or more system busses and/or one or more interface circuits such as PC chipsets 27. The components of the server 4 may be on a single card, logic circuit, and/or chip or alternatively may be on multiple cards, logic circuits, and/or chips. The above server may also be configured as a standalone unit similar to suitable standalone units made by Gilat Satellite Networks, Inc under the trademark Skystar Advantage™. The VSAT antenna may be connected via the satellite interface 24 and/or the external satellite transceiver 26.

In operation, the satellite system 1 may be variously configured. For example, it is often desirable to configure the operating parameters of the system such that a fixed size is utilized for the inbound data slot (e.g., the size of the frequency component and/or the size of the time component are fixed and sized based on the amount and mix of traffic in the system). For example, a single inbound transmission might constitute a 153 Kbps frequency slice that is available for 50 ms. Thus, the data slot size may be configured as 7.65 Kbps (50 ms×153 Kbps) and utilized by each inbound channel, or a plurality of inbound channels.

With reference to FIG. 1, at the computer 4, the data slots are sized to efficiently transfer the data based on average data characteristics for the system. This way the data can be transferred in an efficient manner overall while being inefficient for certain types of data such as very small packets. In accordance with the present invention, where there are small pieces of data such as objects and/or acknowledgements, it may be desirable to store a predetermined amount of this data before capturing a data channel. In the event that the amount of data is not ready for transmission before a time out period, it may be desirable to transmit the data even though the entire data slot may not be utilized. In this manner, the system may be optimized for traffic patterns on a system having a fixed data slot size and a mix of different traffic patterns. The present invention thus helps to optimize the data slot utilization for different types of customers (e.g., business, residences, multi-dwelling units) and/or for different types of data (e.g., file transfers, web access, voice packets, and/or transmission of acknowledgement packets) even with fixed data slot sizes. In typical systems, the data slot size that the satellite system allocates to the inbound data is fixed during any individual period. Thus, it is desirable to have additional mechanisms to help to fully utilize the predetermined data slot size even where much of the packet traffic for an individual user is significantly smaller than the data slot size.

In exemplary embodiments, the efficiency of the system may be substantially increased by sending multiple packets per data slot. For example, where a web page contains many objects, it may be desirable to aggregate the acknowledgements into a single data slot rather than sending each in a different data slot as soon as it is received. This also applies to other packets which are smaller than the data slot size. For example, in some protocols that may be utilized by the LAN 10 and/or server 4, the packets being sent by the user to the satellite may be of various sizes (e.g., 64 bytes to 1024 bytes). Thus, in aspects of the present invention, the system may aggregate two, three, four, or more packets to more fully utilize the allocated data slot. In accordance with aspects of the invention, the data packets may continue to be aggregated in the computer 4 until there is enough information to fill the data slots or until an aggregation time limit expires.

Referring to FIG. 4, in one exemplary embodiment of the invention, various packets 31, 32 may be collected in an input queue 30. The packets 31, 32 may be variously configured, but typically include a source address 33, a destination address 34, data 35, and a check field such as CRC 36. For any particular device, the packets may 31, 32 may be of a variable and/or fixed length. Where the packet size is smaller than the data slot size of the inbound channel, it may be desirable to aggregate one or more packets together in an output queue such as that shown at 40 in FIG. 4.

Referring to the output queue 40 of FIG. 4, it may be desirable to aggregate the packets in order of receipt in the inbound queue for certain applications. However, for other applications, the outbound queue may be organized by selecting individual packets in the inbound queue to make the most efficient use of the data slots. For example, a relative long packet (packet F) and two relatively short packets (packet A and packet B) may be aggregated into a single time slot 41. Similarly, where a longer data packet fills all or nearly all of the data slot, it may be sent without aggregation with any other data packet. Similarly, where a number of closely spaced smaller packets (e.g., acknowledgement packets and/or requests for WEB objects) are closely spaced in time, they may be aggregated into a single data slot such as 44.

In some exemplary embodiments, these packets may be selected from any of the packets in the input queue 30. Alternatively, certain packets may be given priority such as voice packets. Thus, a voice packet may be selected over a data packet, even though a data packet was received first in the input queue. Similarly, where a smaller packet would fit in the remaining space in a data slot it may be selected over a longer packet that arrived first in the data queue, but may not fit in the available space left in the data slot.

Again referring to FIGS. 1 and 2, the aggregation may be most efficient in multi-dwelling units, home LANs, and/or office buildings. In this manner, requests from multiple users may be aggregated and supplied to the inbound path on the uplink. Thus, systems with multiple users may be easily integrated into the same network with systems having single users while at the same time efficiently using a data slot with a fixed size.

Further, the system has advantages in that the aggregation may be accomplished transparently to the computer 4 of the end user. For example, the satellite interface (transceiver) 24, the external satellite interface (transceiver) and/or a standalone units such as the Skystar Advantage™ may handle all of the packet to data slot translation completely transparently to any connected PCs, telephones, and/or settop units. Thus, the software in the computers 4 need not be modified to implement aspects of the present invention.

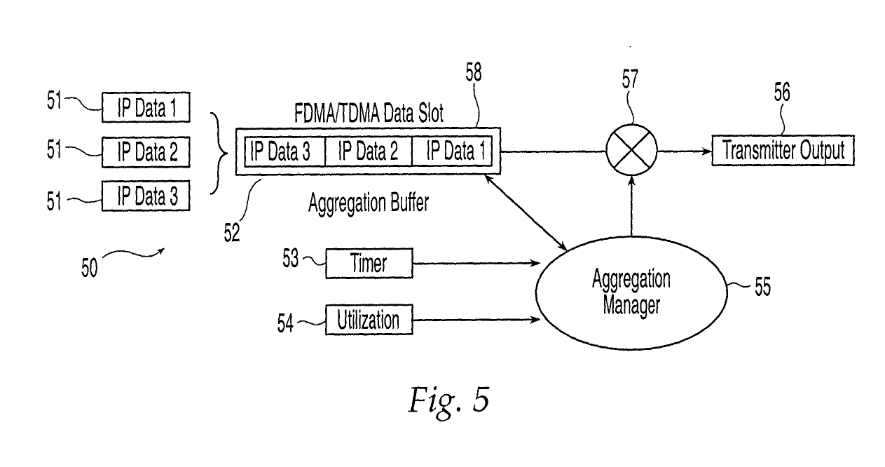

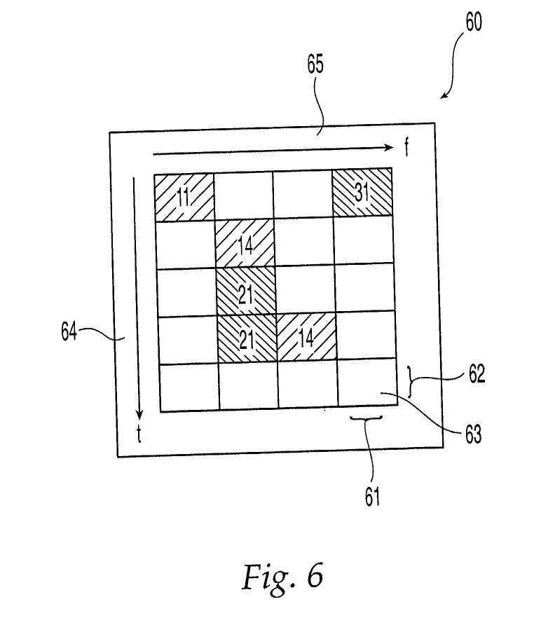

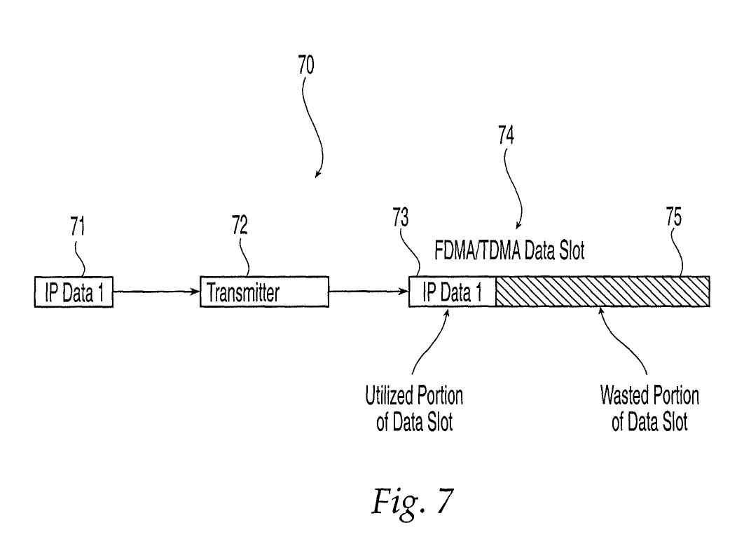

Referring to FIG. 5, another exemplary embodiment of the invention is shown where the system 50 receives a plurality of input data 51 which may be formatted in any conventional packet or other structure. In the most preferred embodiments, the input data is formatted as IP packets. The input data may be received serially and/or accessed as part of a parallel input buffer as discussed above with respect to FIG. 4. The input data may then be aggregated as, for example, in aggregation buffer 52. The contents of the aggregation buffer 52 may be output into the data slot 58 under control of the aggregation manager 55. The size and configuration of the data slot 58 are typically determined by the system, most often by setup software in the Hub. This information is transmitted to each of the remote transceiver stations and utilized by the aggregation manager 55 in each of these transceivers to determine the data slot size.

An aggregation time and/or target utilization may be established for the transceiver in each VSAT terminal. These parameters may be set the same for each VSAT terminal and/or may be adjusted to provide different classes of service. For example, VSAT terminals at a business location may pay a premium for a higher class of service with reduced latency. Similarly, where the system is used for telephone traffic, video traffic, and/or other times sensitive applications, the data packets associated with those applications and/or all data packets from the data station may be assigned a higher class of service. The higher class of service may, for example, set a lower aggregation time and/or lower data slot utilization threshold for the particular VSAT terminal location, for particular data packets at a particular VSAT terminal, for particular data associated with one or more devices (e.g., phones), and/or for particular data associated with particular applications (e.g., video). The utilization and/or time limits may be determined by the aggregation manager 55. The aggregation manager 55 may be variously configured. For example, the aggregation manager 55 (and associated timer 53/data slot utilization manager 54) may implement the input/output queue structure discussed above with respect to FIG. 4 and may be operated as software running in one or more CPU's 20 (FIG. 3), in the satellite interface 24, and/or in the external satellite transceiver 26. After the data packets are aggregated in the data slots or the aggregation time limit has been reached, the data slot may be output via a modulation mechanism 57 to the output of the transmitter and to the satellite 2.

Again referring to FIG. 5, the aggregation manager 55 may utilize any number of parameters including the type of data in the packet 51, the class of service assigned to the terminal, the time of day, day of week, and the overall data slot size currently allocated by the system. The aggregation manager 55 may determine and/or be assigned from the hub various parameters for controlling the aggregation. In one exemplary embodiment, the aggregation manager 55 may be configured to utilize a timer 53 having an aggregation time period and data slot utilization manager 54 having a utilization parameter. The aggregation time period may determine a time period after which the input data will be sent unconditionally (without regards to the required utilization) to prevent data from not ever being transmitted. The utilization parameter 54 may be set to determine a minimum utilization of the data slot required for the input data to be transmitted. For example, where the data slot is 70%, 80%, or 90% utilized, the input data may be transmitted anyway without regard to whether the aggregation time period has been reached.

In the case of a single VSAT serving as a gateway to multiple data sources (e.g., FIG. 2), the probability of enhancing the system utilization, depends on the number of packets sent within the timer period, and the size of the packets. For Internet web browsing, in a multi-dwelling unit (apartment situation) or an Internet cafe with an average of 15 active users, and using an average inbound packet size of, for example, 120 bytes, the proposed system and method can enhance the spectrum utilization by 50% on the return channel (inbound) of the satellite.

Thus, by the simple implementation of a delay/aggregation scheme with or without the use of an aggregation limit timer, the VSAT transmissions may efficiently utilize the system regardless of the size of the input data packets that are actually being sent. This substantially reduces the inefficiencies where small packets only utilize only a fraction of the data slots. Embodiments of the present invention efficiently utilize the channel even where the input data packets are small and the system comprises mixed uses such as multi-dwelling units combined with individual residential units.

We claim:

1. A method of operating a two-way communication satellite communicating comprising:
communicating using a random access scheme with a satellite;
collecting data to be sent by the remote terminal until the data exceeds a predetermined threshold amount of data as determined by the particular random access characteristics or until a time out period has expired; and
transmitting the data.

2. A plurality of end user terminals configured to communicate in a two-way satellite communication system, each of the end user terminals comprising:
a computer communicating with the two-way satellite communication system using a random access scheme, the computer collecting data to be sent by the remote terminal until the data exceeds a predetermined threshold amount of data as determined by the particular random access characteristics or until a time out period has expired and then transmitting the data.
